(19) United States
(12) Patent Application Publication
(10) Pub. No.: US 2019/0061119 A1
(43) Pub. Date: Feb. 28, 2019

(54) QUICK-CHANGE CONNECTING MECHANISM AND QUICK-CHANGE SCREWDRIVER

(71) Applicant: XIAMEN NANCHBIT PRECISION TOOLS CO., LTD., Xiamen City (CN)

(72) Inventor: Li Nan WANG, XIAMEN CITY (CN)

(21) Appl. No.: 15/895,515

(22) Filed: Feb. 13, 2018

(30) Foreign Application Priority Data
Aug. 30, 2017 (CN) 201710760800.7

(51) Int. Cl. B25B 23/00; B23B 31/107; B25B 15/00

(52) U.S. Cl. CPC B25B 23/0035; B25B 23/0042; B23B 2231/46; B25B 15/005; B23B 2231/0232; B23B 31/1071

(57) ABSTRACT

A quick-change connecting mechanism and a quick-change screwdriver of the invention. Firstly, a connecting handle and an accommodating cavity are matched in a shaft-hole mode, during actual production and machining, the machining precision of round shafts and round holes is high, the matching and mounting precision of the round shafts and the round holes is much higher than that of hexagonal shafts and hexagonal holes, and thus the axial precision of the connecting handle or screwable tips is ensured after mounting; secondly, longitudinal locking bodies are arranged and longitudinally inserted into locking grooves in an abutting mode under the effect of a sliding sleeve, so that rotation torque is transmitted in the circumferential direction, and the torque of a connecting rod is transmitted to the connecting handle or the screwable tips. Meanwhile, the connecting handle is fixed in the mounting direction and is prevented from falling.

### BACKGROUND OF THE INVENTION

### Technical Field

The invention belongs to the technical field of fastening structures, in particular to a fastening structure of a quick-change connecting mechanism, and a quick-change screwdriver.

### Description of Related Art

Screwdrivers are widely applied in various industries such as the mechanical, electrical, electronic, automobile, glasses, clock industries and household DYI, and the screwdrivers are of various types and have different functions, lengths and sizes. In the functional aspect, combined type screwdrivers with quick-change screwdriver heads are convenient to use, thereby being extremely popular to industries and on the market at present. Two types of screwdriver heads are basically adopted by various existing screwdrivers with replaceable screwdriver heads, for one type, the screwdriver heads are hexagonal, and the basic specifications of the hexagonal screwdriver heads are ¼ inch for opposite sides, namely 6.35 mm/5 mm/4 mm/3 mm; for the other type, the screwdriver heads are cylindrical, and the main specifications of the cylindrical screwdrivers are Φ6/Φ5/Φ4/Φ3 and the like; a quick-change device corresponding to the hexagonal screwdriver heads has to be provided with a hexagonal hole matched with the hexagonal screwdriver heads so that screwdrivers can rotate accordingly in use, however, the problem that the hexagonal screwdriver heads slide out of the hexagonal hole and falls needs to be solved; to solve the problem, a hole is punched in the wall of the hexagonal hole of the quick-change device, a steel ball is mounted in the hole and pressed on the outer wall of the hexagonal screwdrivers from the outside through a spring retainer ring, or a magnet is directly mounted at the bottom of the hexagonal hole to attract the hexagonal screwdriver heads, and thus the hexagonal screwdriver heads are prevented from falling in use.

To make the cylindrical screwdrivers rotate accordingly, two ribs (commonly known as lugs) with the specifications greater than the diameter need to be machined (generally punched) on the tail of a cylinder, and straight slots used for accommodating the two lugs need to be formed in a round hole of a quick-change device; similarly, to prevent the screwdriver heads from falling in use, a steel ball and a spring retainer ring are needed or a magnet at the bottom is needed for attracting the screwdriver heads. As the round hole is easy to machine, an external thread and a crossed opening can also be machined at the front end of the round hole of the quick-change device, and a cylindrical screwdriver bar is locked to the quick-change device through a nut internally provided with a neck.

The external structures of the two types of screwdriver heads mentioned above are dominant on the present market for several decades. As the hexagonal hole is difficult to machine and poor in machining precision, the hexagonal screwdriver heads cannot be tightly and perfectly matched with the hexagonal hole of the quick-change device and shake due to the existence of gaps. Screwdriver heads produced in Germany, Japan, Taiwan and China all have the problem. For the cylindrical screwdriver heads, since two lugs are additionally arranged and two straight slots need to be machined in the round hole, the problem of shaking caused by gaps still exists. Although fastening fit is achieved through nut locking, operation is complex, and screwdriver heads can only be changed, but cannot be changed quickly.

### BRIEF SUMMARY OF THE INVENTION

The invention aims to provide a quick-change connecting mechanism to solve the problems that an existing quick-change connecting mechanism for screwdrivers is low in precision and poor in connecting firmness.

The specific scheme is as follows: a quick-change connecting mechanism comprises:

a connecting rod and a connecting handle, wherein the connecting rod is provided with an accommodating cavity which extends along a rotation axis, one side of the accommodating cavity is open, and the connecting handle is placed and accommodated in the accommodating cavity from the open side; the accommodating cavity is provided with mounting through holes penetrating into the accommodating cavity in the radial direction;

locking bodies, wherein the locking bodies are arranged in the mounting through holes and can move in the mounting through holes to get close to or away from the connecting handle;

a sliding sleeve, wherein the sliding sleeve is movably mounted on the connecting rod and has a locking position and a release position; when located at the locking position, the sliding sleeve abuts against the locking bodies and enables the locking bodies to be inlaid in the accommodating cavity to abut against the connecting handle; when located at the release position, the sliding sleeve releases the locking bodies and enables the locking bodies to be separated from the connecting handle;

the connecting handle is provided with a cylindrical positioning section, correspondingly, the accommodating cavity is provided with a mounting hole matched with the positioning section, and the mounting hole is coaxial with the rotation axis of the connecting rod; the connecting handle is mounted in the accommodating cavity, the positioning section is mounted in the mounting hole so as to be matched with the mounting hole, and thus the connecting handle is accurately positioned in the axial direction;

locking grooves are further formed in positions, corresponding to mounting through holes, of the connecting handle; when the sliding sleeve is located at the locking position, the locking bodies can stretch into the accommodating cavity and be inserted into the locking grooves, and thus the connecting handle is fixed in the rotation direction of the connecting rod.

Furthermore, the locking grooves are formed in the outer side face of the connecting handle and approximately extend in the direction of the rotation axis of the connecting handle, and the sections of the locking grooves are matched with the abutting ends of the locking bodies.

Furthermore, the number of locking sliding grooves is more than one, and the multiple locking sliding grooves are evenly distributed in the connecting handle in the circumferential direction; correspondingly, each locking body is arranged at the position, corresponding to one locking sliding groove, of the connecting rod.

Furthermore, the locking sliding grooves are formed in the positioning section of the connecting handle, and correspondingly, the mounting through holes are formed in the wall of the mounting hole.

Furthermore, the sliding sleeve is arranged on the accommodating cavity of the connecting rod in a sleeving mode, and an abutting surface is arranged in the area, corresponding to the mounting through holes, of the inner wall of the sliding sleeve and used for abutting against the locking bodies;

a spring is arranged on the connecting rod and applies acting force to the sliding sleeve, so that the sliding sleeve is made to move towards the locking position from the release position; under the effect of the spring, the sliding sleeve is located at the locking position, and the abutting surface abuts against the locking bodies in the radial direction and inlays the locking bodies in the accommodating cavity.

Furthermore, in the direction opposite to the moving direction of the sliding sleeve under the acting force of the spring, the distance between the abutting surface and the rotation axis of the connecting rod is decreased gradually, so that a self-tightening assembly is formed by the sliding sleeve and the locking bodies.

Furthermore, the locking bodies are balls, the locking grooves are columnar grooves, and the spring is a compression spring; a fixed retainer ring is arranged on the connecting rod, and a sealing piece is also included;

the compression spring is arranged on the connecting rod in a sleeving mode, then the sliding sleeve is arranged on the connecting rod in the sleeving mode, and the compression spring is arranged in the sliding sleeve; the sealing piece is fixed to the end, away from the open side of the accommodating cavity, of the sliding sleeve, and the two ends of the compression spring abut against the fixed retainer ring and the sealing piece separately, so that acting force parallel to the mounting direction of the connecting handle is applied to the sliding sleeve; the spring force of the compression spring is overcome in the direction opposite to the mounting direction, so that the sliding sleeve is pushed to reach the release position, and accordingly the connecting handle is released.

Furthermore, the locking bodies are pin rollers, the locking grooves are columnar grooves, and the spring is a torsion spring; the pin rollers and the columnar grooves are parallel to the rotation axis of the connecting rod;

the torsion spring is arranged on the connecting rod in a sleeving mode, then the sliding sleeve is arranged on the connecting rod in a sleeving mode, the torsion spring is arranged in the sliding sleeve, and two torsion arms of the torsion spring act on the connecting rod and the sliding sleeve separately, so that acting force for making the sliding sleeve rotate around the connecting rod is applied to the sliding sleeve.

The invention further provides a quick-change screwdriver which comprises the quick-change connecting mechanism; a screwable tip is formed at one end of the connecting handle, so that a screwdriver head is formed; the locking bodies and the sliding sleeve are arranged on the connecting rod, so that a holder is formed, and the screwdriver head is fixedly mounted through the holder.

Furthermore, screwable tips with different specifications are formed at the front end and the rear end of the connecting handle separately; the positioning section is formed on the middle section of the connecting handle, and the locking grooves are formed in the positioning section.

According to the quick-change connecting mechanism and the quick-change screwdriver of the invention, firstly, the connecting handle and the accommodating cavity are matched in a shaft-hole mode, during actual production and machining, the machining precision of round shafts and round holes is high, the matching and mounting precision of the round shafts and the round holes is much higher than that of hexagonal shafts and hexagonal holes, and thus the axial precision of the connecting handle or the screwable tips is ensured after mounting; secondly, the longitudinal locking bodies are arranged and longitudinally inserted into the locking grooves in an abutting mode under the effect of the sliding sleeve, so that rotation torque is transmitted in the circumferential direction, and the torque of the connecting rod is transmitted to the connecting handle or the screwable tips, and meanwhile, through the cooperation between the locking bodies and the locking grooves, the connecting handle is fixed in the mounting direction and is prevented from falling.

In a further technical scheme, the sliding sleeve comprises a sliding sleeve body, the sliding sleeve body tightly presses the locking bodies through the oblique abutting surface under the elastic force of the spring, and thus self-locking in the mounting direction is achieved; the sliding sleeve body can be pushed to relieve the locking state, and operation is more convenient.

### BRIEF DESCRIPTION OF THE SEVERAL VIEWS OF THE DRAWINGS

FIG. 1 shows a structural diagram of a quick-change screwdriver in one embodiment of the invention;

FIG. 2 shows a longitudinal sectional view of FIG. 1;

FIG. 3 shows a local enlarged view of the portion A in FIG. 2;

FIG. 4 shows a transverse sectional view of FIG. 1;

FIG. 5 shows a side view of a screwdriver head in FIG. 1;

FIG. 6 shows a structural diagram of FIG. 5;

FIG. 7 shows a sectional view of FIG. 5;

FIG. 8 shows a structural diagram of a connecting rod in FIG. 1;

FIG. 9 shows a structural diagram of a quick-change screwdriver in a second embodiment of the invention;

FIG. 10 shows a sectional view of FIG. 9;

FIG. 11 shows a structural diagram of FIG. 9 after a sliding sleeve is detached;

FIG. 12 shows a structural diagram of a screwdriver head in FIG. 9;

FIG. 13 shows a structural diagram of a third embodiment of the invention after an outer sleeve is detached;

FIG. 14 shows a structural diagram of a screwdriver head in a fourth embodiment of the invention.

### DETAILED DESCRIPTION OF THE INVENTION

The drawings are provided for further describing the embodiments of the invention. These drawings are only part of the content disclosed by the invention and mainly used for describing the embodiments and can explain the operating principle of the embodiments in cooperation with relevant illustration in the description. By referring to the content, those ordinarily skilled in the field can understand other possible execution modes and advantages of the invention. Components in the drawings are not drawn in proportion, and similar component symbols are generally used for representing similar components.

A further description of the invention is given with the accompanying drawings and specific embodiments as follows.

### First Embodiment

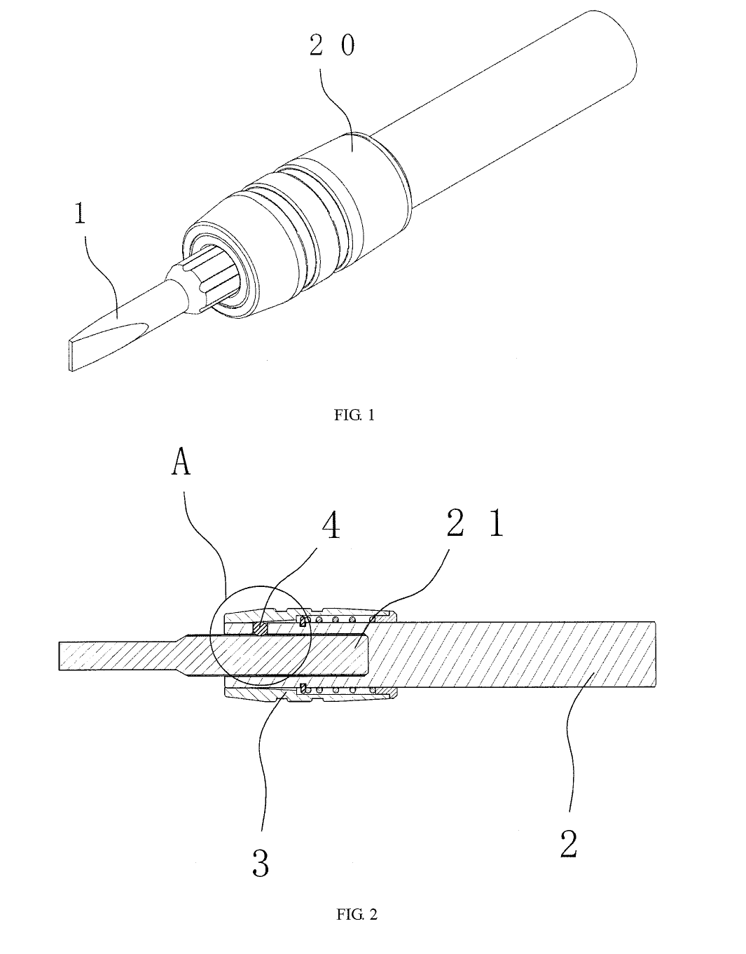

As is shown in FIG. 1 and FIG. 2, the embodiment provides a quick-change screwdriver which comprises a handle lever (not shown in the FIGs) and a screwdriver head 1, wherein the screwdriver head 1 is mounted on a tool bar through a quick-change connecting mechanism, and the quick-change connecting mechanism comprises a holder 20 mounted on the handle lever.

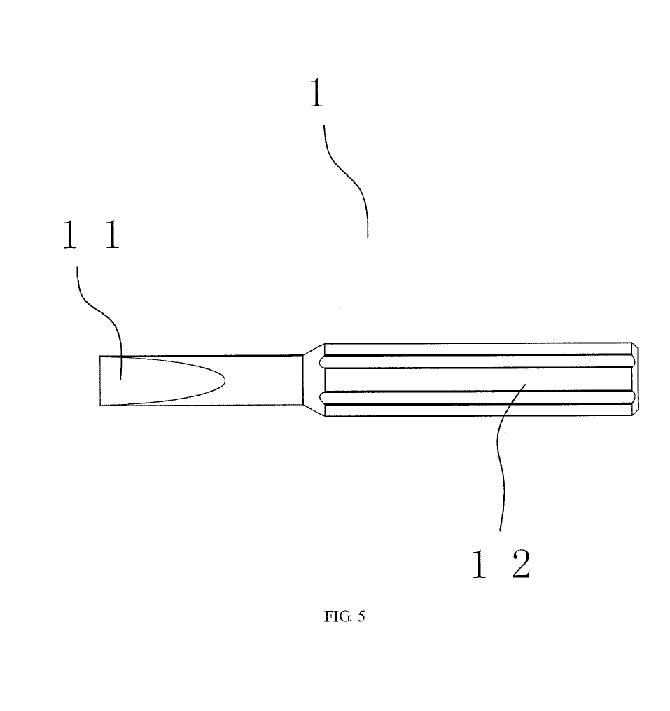

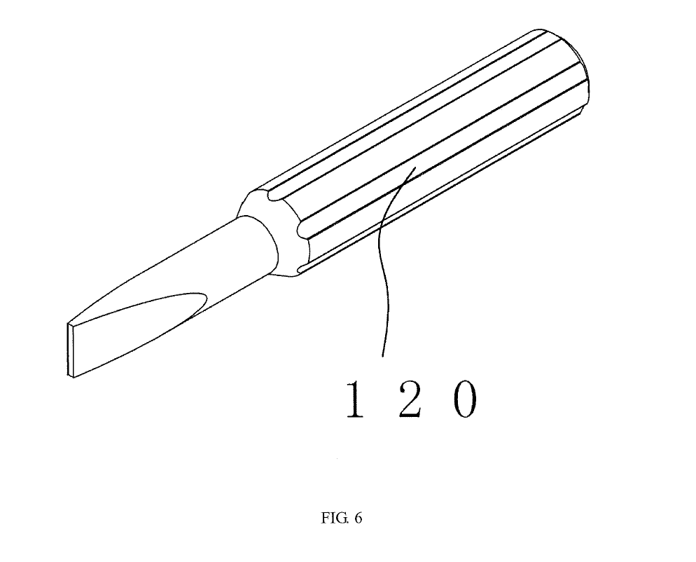

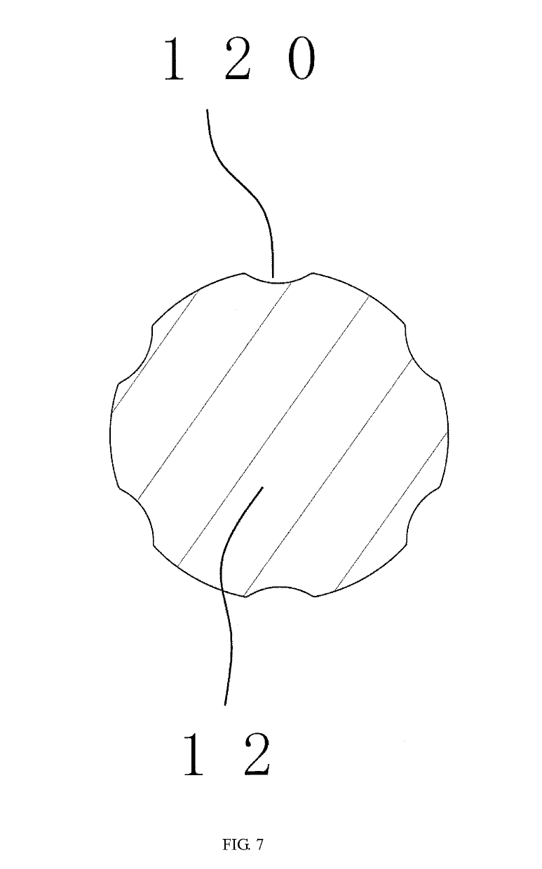

As is shown in FIG. 5 and FIG. 6, the screwdriver head 1 serves as a connecting handle and is mounted on the handle lever through the holder 20; a screwable tip 11 is formed at the front end of the screwdriver head 1, in the embodiment, the screwable tip 11 is a slotted screwdriver bit, the rear end of the screwdriver head 1 is of a cylindrical rod structure, the rod structure at the rear end of the screwdriver head 1 is defined as a positioning section 12, the front end of the screwdriver head 1 faces a screw, and the rear end of the screwdriver head 1 faces the handle lever.

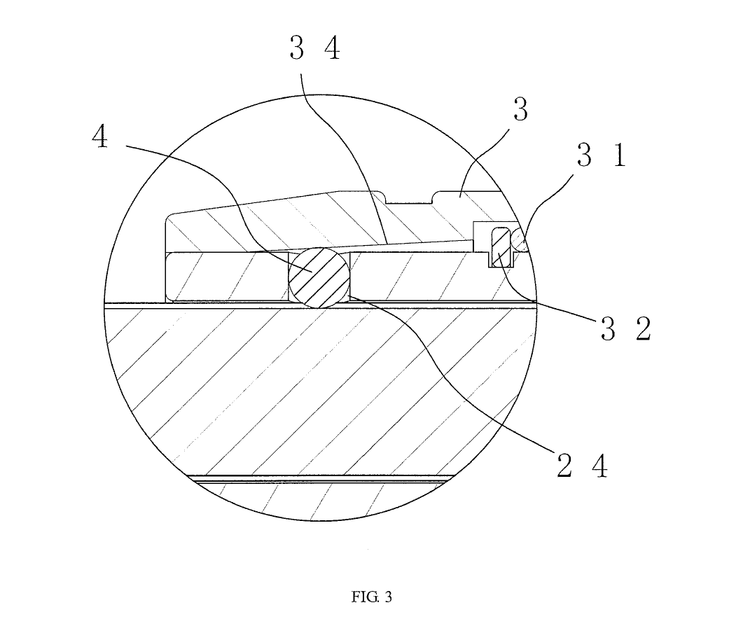

As is shown in FIG. 2 and FIG. 3, the holder 20 comprises a connecting rod 2, and locking bodies and a sliding sleeve 3 are arranged on the connecting rod 2, specifically:

the connecting rod 2 can rotate when a screw is dismounted and has a rotation direction and a rotation axis, and the connecting rod 2 is a cylinder structure which extends in the length direction of the rotation axis; the end, towards the screwdriver head 1, of the connecting rod 2 is the front end, and the front end of the connecting rod 2 is provided with an accommodating cavity 21 with the front end open; in the embodiment, the accommodating cavity 21 is a cylindrical cavity and extends in the rotation axis of the connecting rod 2; the accommodating cavity 21 is matched with the positioning section 12 of the screwdriver head 1 and serves as a mounting hole, the screwdriver head 21 is placed in the accommodating cavity 21 from the open side, the accommodating cavity 21 is in clearance fit with a shaft hole of the positioning section 12, and the rotation axis of the accommodating cavity 21 is coaxial with the rotation axis of the connecting rod 2, so that the positioning section 12 and the connecting rod 2 are precisely connected, and the axial precision of the screwdriver head 1 serving as the connecting handle is ensured. On the premise that the positioning section 12 is coaxial with the screwable tip 11, the screwable tip 11 is coaxial with the rotation axis of the connecting rod 2.

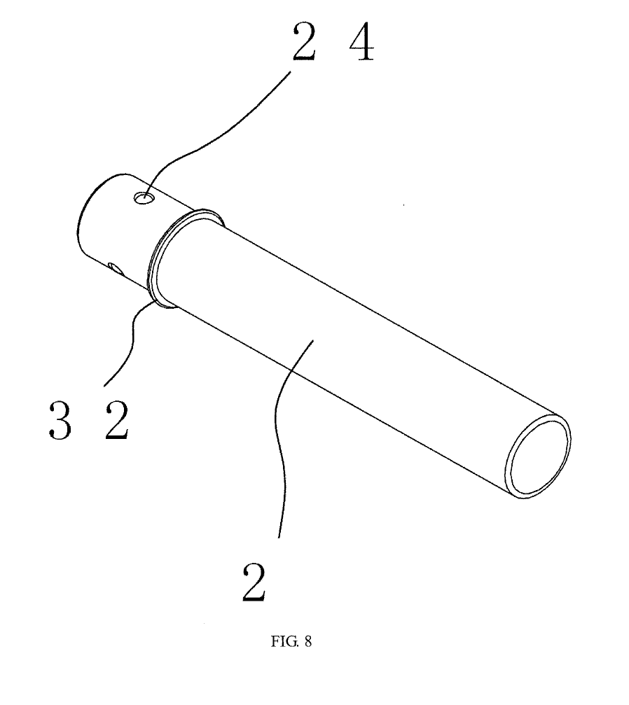

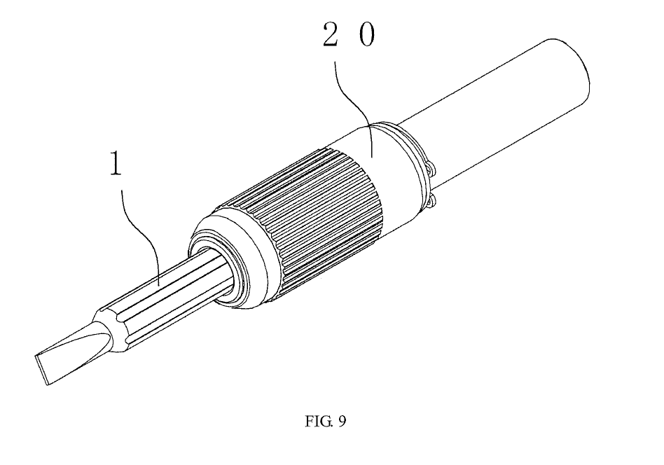

As is shown in FIG. 6 and FIG. 7, locking sliding grooves 120 are further formed in the outer side wall of the positioning section 12 of the screwdriver head 1; in the embodiment, the section of each locking sliding groove 120 is sectorial face or a semicircular face and extends linearly in the axis direction of the positioning section 12 of the screwdriver head 1. In the embodiment, the number of the locking sliding grooves 120 is six, the six locking sliding grooves 120 are evenly distributed in the positioning section 12 in the circumferential direction, and the two ends of each locking sliding groove 120 penetrate through the wall of the positioning section 12 in the length direction.

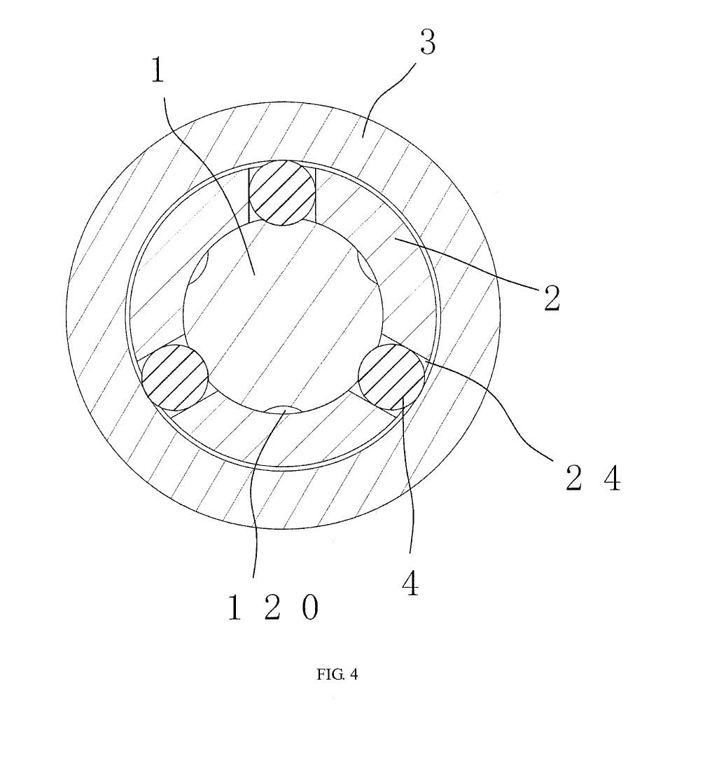

As is shown in FIGS. 2-4, mounting through holes 24 penetrating into the accommodating cavity 21 in the radial direction are formed in the wall of the accommodating cavity 21, in the embodiment, the mounting through holes 24 are spherical, and the two ends of each mounting through hole 24 are communicated; balls 4 serving as the locking bodies are placed into the mounting through holes 24 from outer ports of the mounting through holes 24, and the bottoms of the balls 4 protrude into the accommodating cavity 21; for mounting the balls 4, the diameter of the opening, towards the accommodating cavity 21, of each mounting through hole 24 is smaller than the outer diameter of each ball 4, and the diameter of the other opening of each mounting through hole 24 is greater than the outer diameter of each ball 4.

In the embodiment, the number of the mounting through holes 24 is three, the three mounting through holes 24 are evenly distributed in the circumferential direction with the rotation axis of the connecting rod 2 as the axis, and thus the balls 4 can move in the mounting through holes 24 in the radial direction and can partially protrude into the accommodating cavity 21 to be inserted into the locking sliding grooves 120 of the screwdriver head 1, rotation of the screwdriver head 1 relative to the connecting rod 2 is limited, and the rotation direction of the screwdriver head 1 relative to the connecting rod 2 is fixed.

For fixing the balls 4, the sliding sleeve on the connecting rod 2 comprises a cylindrical sliding sleeve body 3 and a compression spring 31.

A fixed retainer ring 32 is arranged on the connecting rod 2, and the compression spring 31 is arranged on the connecting rod 2 in a sleeving mode from the side away from the screwdriver head 1 and abuts against the fixed retainer ring 32; then the sliding sleeve body 3 is arranged on the connecting rod 2 in a sleeving mode, and the compression spring 31 is arranged in the sliding sleeve body 3; a sealing piece is fixed to the end, away from the open side of the accommodating cavity 21, of the sliding sleeve body 3, and the two ends of the compression spring 31 abut against the fixed retainer ring 32 and the sealing piece separately, so that acting force parallel to the mounting direction of the screwdriver head 1 is applied to the sliding sleeve body 3.

It can be understood that the compression spring 31 can also be a tension spring, and the technical effect of the invention can also be achieved even if the mounting position of the compression spring 31 is changed.

Wherein, at least part of the sliding sleeve body 3 is arranged on the accommodating cavity 21 of the connecting rod 2 in a sleeving mode, so that the mounting through holes 24 are covered. The area, corresponding to the mounting through holes 24, of the inner wall of the sliding sleeve body 3 is arranged obliquely, so that an abutting surface 34 is formed, and the abutting surface 34 inclines by an acute angle relative to the mounting direction of the screwdriver head 1.

The operating principle of the sliding sleeve is as follows:

Under the effect of the compression spring 31, the sliding sleeve moves in the mounting direction of the screwdriver head 1 till the abutting surface 34 abuts against the balls 4 in the radial direction, the bottom ends of the balls 4 are inlaid into the accommodating cavity 21 so as to be clamped into the locking sliding grooves 120, and the sliding sleeve is located at the locking position at the moment;

when the sliding sleeve is located at the locking position, the abutting surface 34 inclines by an acute angle relative to the mounting direction of the screwdriver head 1 so that the screwdriver head 1 can disengage from the accommodating cavity 21 only in the direction opposite to the mounting direction to upwards abut against the balls 4 and to push the balls 4 to rotate; in the process, the balls 4 bear force to push the abutting surface 34 backwards, the pressure applied to the balls 4 by the abutting surface 34 is increased, and accordingly a self-tightening assembly is formed by the balls 4 and the sliding sleeve;

then, the spring force of the compression spring 31 is overcome in the direction opposite to the mounting direction, so that the sliding sleeve body 3 is pushed, then the abutting surface 34 moves away from the balls 4 so that the screwdriver head 1 can be pulled out, and the sliding sleeve body 3 reaches the release position.

In the moving direction of the sliding sleeve body 3 under the acting force of the compression spring 31, namely in the moving direction from the release position to the locking position, the balls 4 can be tightly pressed in real time through the compression spring 31 as long as the distance between the abutting surface 34 and the rotation axis of the connecting rod 2 is decreased gradually, and thus a self-tightening assembly is formed by the sliding sleeve and the balls 4 serving as the locking bodies.

The above embodiment is regarded as the optimal execution mode by the inventor, and it can be understood that the following specific execution modes can also obtained according to the technical concept of the application:

(1) In the above embodiment, the screwdriver head 1 serves as the connecting handle, and the cylindrical positioning section 12 is located at the rear end of the screwdriver head 1; similarly, part of the screwdriver head or the connecting handle can also be used as the cylindrical positioning section, and the other part of the screwdriver head or the connecting handle is used as a non-positioning section; correspondingly, the accommodating cavity can also be not of the cylindrical cavity structure and just needs to be partially provided with a round hole matched with the positioning section to ensure that the screwdriver head and the connecting rod are assembled in a shaft-hole mode on a certain section.

(2) In the above embodiment, the locking sliding grooves 120 are formed in the positioning sections 12; similarly, the locking sliding grooves can also be formed in other areas of the connecting handle or the screwdriver head, and the same function can be achieved as long as the locking sliding grooves can be matched with locking bodies in an insertion mode; in the simplest way, one locking groove such as a spherical groove or a columnar groove is formed in the portion, corresponding to the mounting through holes, of the connecting handle or the screwdriver head, and the basically identical function can also be achieved.

(3) In the above embodiment, the sliding sleeve is mounted movably and driven by elastic force of the spring; in other specific embodiments, the sliding sleeve can also be mounted in a threaded mode or in a buckled mode, and the basic design function can also be achieved.

### Second Embodiment

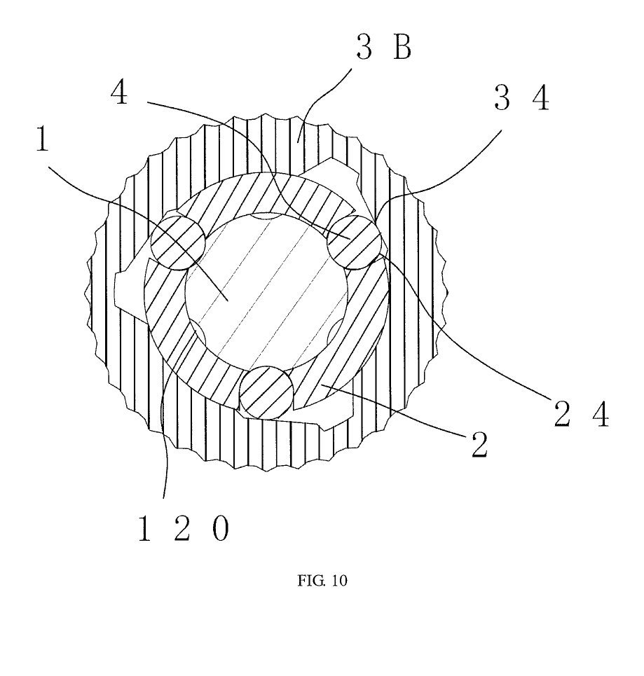

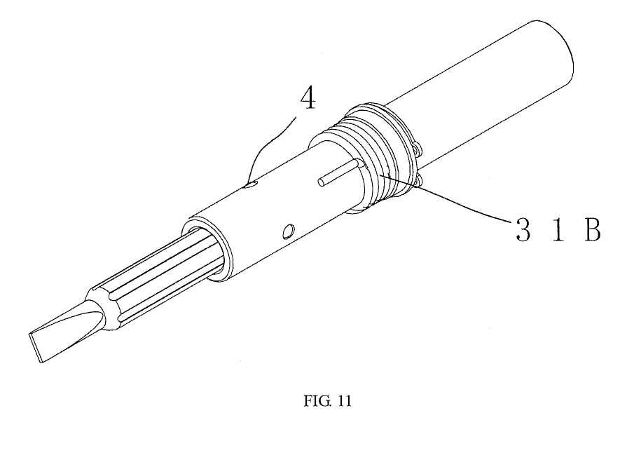

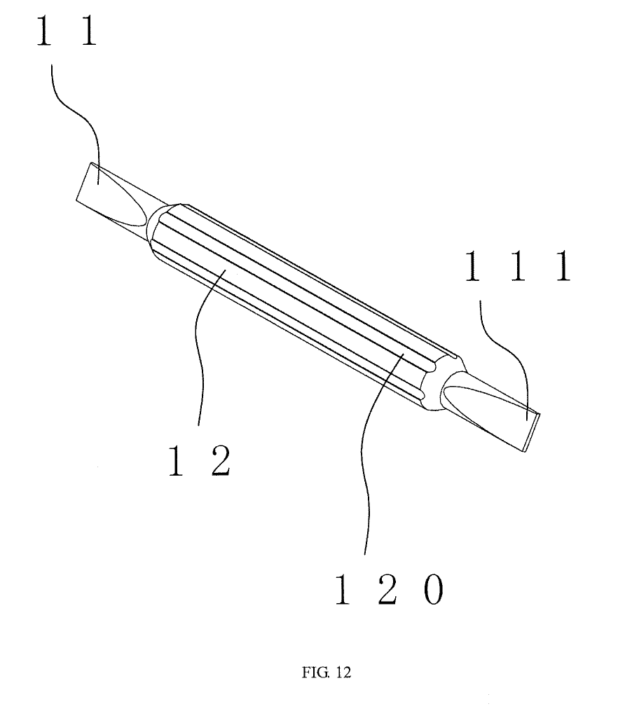

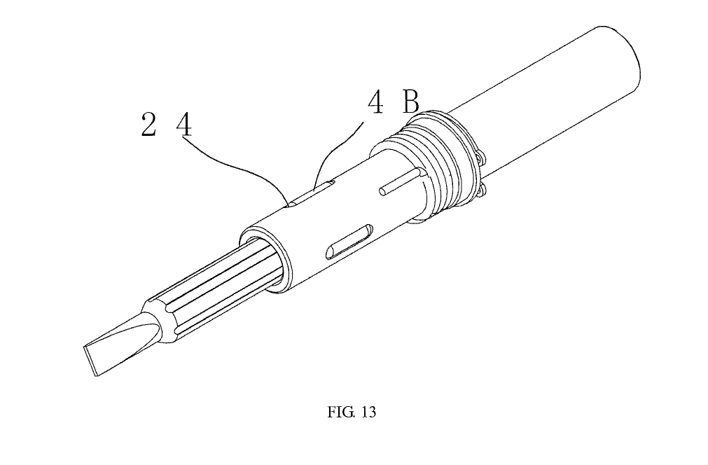

As is shown in FIGS. 9-12, the embodiment provides a quick-change screwdriver which is different from the quick-change screwdriver in the first embodiment:

The embodiment is basically the same as the first embodiment, the quick-change screwdriver comprises a handle lever (not shown in the FIGs) and a screwdriver head 1, wherein the screwdriver head 1 is mounted on a tool bar through a quick-change connecting mechanism, and the quick-change connecting mechanism comprises a holder 20 mounted on the handle lever;

the holder 20 comprises a connecting rod 2, and the connecting rod 2 is provided with locking bodies and a sliding sleeve; the screwdriver head 1 comprises a positioning section 12 and a screwable tip 11, and the positioning section 12 is cylindrical and is provided with locking sliding grooves 120; the locking bodies are balls 4, and the locking sliding grooves 120 are parallel to the axis of the connecting rod 2.

The main differences:

In the embodiment, the sliding sleeve is a rotary sliding sleeve 3B, and the connecting rod 2 is sleeved with a torsion spring 31B serving as the spring. The torsion spring 31B is arranged on the connecting rod 2 in a sleeving mode and can rotate around the rotation axis of the connecting rod 2, then the rotary sliding sleeve 3B is arranged on the connecting rod 2 in a sleeving mode, the torsion spring 31B is arranged in the rotary sliding sleeve 3B, and two torsion arms of the torsion spring 31B act on the connecting rod 2 and the rotary sliding sleeve 3B separately, so that acting force for making the rotary sliding sleeve 3B to rotate around the connecting rod 2 is applied to the rotary sliding sleeve 3B.

The abutting surface 34 is an oblique plane extending in the length direction of the connecting rod 2, and in the rotation direction of the sliding sleeve around the axis under the acting force of the torsion spring 31B, the distance between the abutting surface 34 and the rotation axis of the connecting rod 2 is decreased gradually, so that a self-tightening assembly is formed by the sliding sleeve and the balls 4.

Screwable tips with different specifications, namely the first screwable tip 11 and the second screwable tip 111, are formed at the front end and rear end of the screwdriver head 1 separately; the positioning section 12 is formed on the middle section of the screwdriver head 1, and the locking grooves 120 are also formed in the positioning section 12.

### Third Embodiment

As is shown in FIG. 13, the embodiment is basically the same as the second embodiment and is different from the second embodiment mainly in that:

the locking bodies are pin rollers 4B, the mounting holes 24 are columnar through holes matched with the pin rollers 4B, the two opposite side faces of each mounting hole 24 are open, and the spring is a torsion spring; the pin rollers 4B and the mounting holes 24 are parallel to the rotation axis of the connecting rod.

### Fourth Embodiment

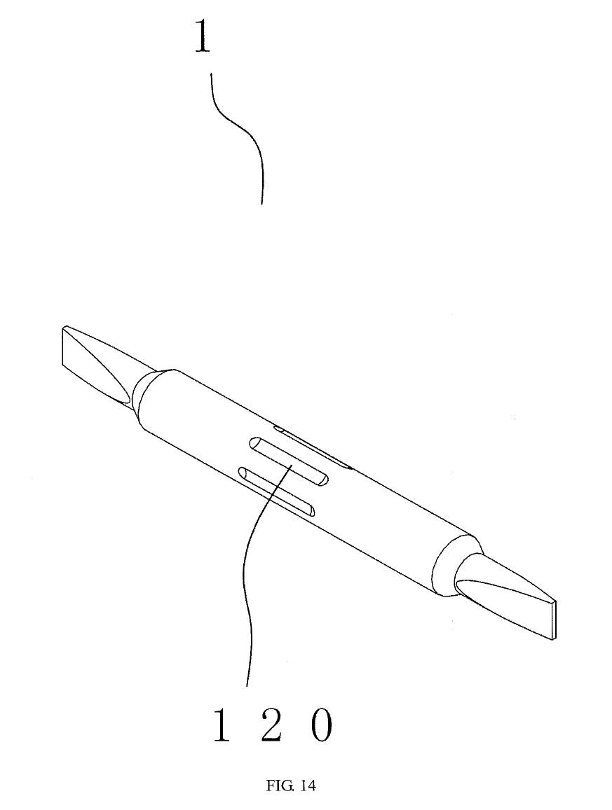

As is shown in FIG. 14, the embodiment is basically the same as the third embodiment and is different from the third embodiment mainly in that:

The locking grooves 120 in the screwdriver head 1 are columnar grooves matched with pin rollers, and the length of the locking grooves 120 can be matched with the length of the pin rollers; of course, preferably, the locking grooves 120 are lightly longer than the pin rollers, and the technical effect of the invention can also be achieved.

Although the invention is specifically demonstrated and illustrated with the preferred embodiments, it should be understood that for those skilled in the field, various changes of the invention made in form and in detail without deviating from the sprit and scope defined by the claims of the invention are all within the protection scope of the invention.

1. A quick-change connecting mechanism, comprising:
a connecting rod and a connecting handle, wherein the connecting rod is provided with an accommodating cavity which extends along a rotation axis, one side of the accommodating cavity is open, and the connecting handle is placed and accommodated in the accommodating cavity from the open side; the accommodating cavity is provided with mounting through holes penetrating into the accommodating cavity in the radial direction;
locking bodies, wherein the locking bodies are arranged in the mounting through holes and can move in the mounting through holes to get close to or away from the connecting handle;
a sliding sleeve, wherein the sliding sleeve is movably mounted on the connecting rod and has a locking position and a release position; when located at the locking position, the sliding sleeve abuts against the locking bodies and enables the locking bodies to be inlaid in the accommodating cavity to abut against the connecting handle; when located at the release position, the sliding sleeve releases the locking bodies and enables the locking bodies to be separated from the connecting handle;
wherein:
the connecting handle is provided with a cylindrical positioning section, correspondingly, the accommodating cavity is provided with a mounting hole matched with the positioning section, and the mounting hole is coaxial with the rotation axis of the connecting rod; the connecting handle is mounted in the accommodating cavity, the positioning section is mounted in the mounting hole so as to be matched with the mounting hole, and thus the connecting handle is accurately positioned in the axial direction;
locking grooves are further formed in positions, corresponding to mounting through holes, of the connecting handle; when the sliding sleeve is located at the locking position, the locking bodies can stretch into the accommodating cavity and be inserted into the locking grooves, and thus the connecting handle is fixed in the rotation direction of the connecting rod.

2. The quick-change connecting mechanism according to claim 1, wherein the locking grooves are formed in the outer side face of the connecting handle and approximately extend in the direction of the rotation axis of the connecting handle, and the sections of the locking grooves are matched with the abutting ends of the locking bodies.

3. The quick-change connecting mechanism according to claim 2, wherein the number of locking sliding grooves is more than one, and the multiple locking sliding grooves are evenly distributed in the connecting handle in the circumferential direction; correspondingly, each locking body is arranged at the position, corresponding to one locking sliding groove, of the connecting rod.

4. The quick-change connecting mechanism according to claim 2, wherein the locking sliding grooves are formed in the positioning section of the connecting handle, and correspondingly, the mounting through holes are formed in the wall of the mounting hole.

5. The quick-change connecting mechanism according to claim 1, wherein further comprising a spring;
wherein, the sliding sleeve is arranged on the accommodating cavity of the connecting rod in a sleeving mode, and an abutting surface is arranged in the area, corresponding to the mounting through holes, of the inner wall of the sliding sleeve and used for abutting against the locking bodies;
the spring is arranged on the connecting rod and applies acting force to the sliding sleeve, so that the sliding sleeve is made to move towards the locking position from the release position; under the effect of the spring, the sliding sleeve is located at the locking position, and the abutting surface abuts against the locking bodies in the radial direction and inlays the locking bodies in the accommodating cavity.

6. The quick-change connecting mechanism according to claim 5, wherein in the direction opposite to the moving direction of the sliding sleeve under the acting force of the spring, the distance between the abutting surface and the rotation axis of the connecting rod is decreased gradually, so that a self-tightening assembly is formed by the sliding sleeve and the locking bodies.

7. The quick-change connecting mechanism according to claim 5, wherein:
the locking bodies are balls, the locking grooves are columnar grooves, and the spring is a compression spring; a fixed retainer ring is arranged on the connecting rod, and a sealing piece is also included;
the compression spring is arranged on the connecting rod in a sleeving mode, then the sliding sleeve is arranged on the connecting rod in the sleeving mode, and the compression spring is arranged in the sliding sleeve; the sealing piece is fixed to the end, away from the open side of the accommodating cavity, of the sliding sleeve, and the two ends of the compression spring abut against the fixed retainer ring and the sealing piece separately, so that acting force parallel to the mounting direction of the connecting handle is applied to the sliding sleeve; the spring force of the compression spring is overcome in the direction opposite to the mounting direction, so that the sliding sleeve is pushed to reach the release position, and accordingly the connecting handle is released.

8. The quick-change connecting mechanism according to claim 5, wherein:
the locking bodies are pin rollers, the locking grooves are columnar grooves, and the spring is a torsion spring; the pin rollers and the columnar grooves are parallel to the rotation axis of the connecting rod;
the torsion spring is arranged on the connecting rod in a sleeving mode, then the sliding sleeve is arranged on the connecting rod in a sleeving mode, the torsion spring is arranged in the sliding sleeve, and two torsion arms of the torsion spring act on the connecting rod and the sliding sleeve separately, so that acting force for making the sliding sleeve rotate around the connecting rod is applied to the sliding sleeve.

9. A quick-change screwdriver, wherein comprising the quick-change connecting mechanism according to claim 1;
wherein, a screwable tip is formed at one end of the connecting handle, so that a screwdriver head is formed;
the locking bodies and the sliding sleeve are arranged on the connecting rod, so that a holder is formed, and the screwdriver head is fixedly mounted through the holder.

10. The quick-change screwdriver according to claim 9, wherein screwable tips with different specifications are formed at the front end and the rear end of the connecting handle separately; the positioning section is formed on the middle section of the connecting handle, and the locking grooves are formed in the positioning section.
